(19) United States
(12) Patent Application Publication
(10) Pub. No.: US 2015/0096314 A1
(43) Pub. Date: Apr. 9, 2015

(54) HEAT PUMP

(71) Applicant: Carrier Corporation, Farmington, CT (US)

(72) Inventors: Mark Shoemaker, Brownsburg, IN (US); Allen C. Kirkwood, Brownsburg, IN (US)

(73) Assignee: Carrier Corporation

(21) Appl. No.: 14/500,573

(22) Filed: Sep. 29, 2014

Related U.S. Application Data
(60) Provisional application No. 61/887,269, filed on Oct. 4, 2013.

(51) Int. Cl. F25B 41/04; F16K 11/085; F25B 30/02

(52) U.S. Cl. CPC F25B 41/046; F25B 30/02; F16K 11/0853
USPC 62/115; 62/324.6; 137/625.43

(57) ABSTRACT

A heat pump is provided including a plurality of lines having refrigerant flowing therethrough. A reversing valve is provided including a selector mechanism having a plurality of cavities formed therein and extending therethrough. A source of motion is coupled to the selector mechanism for movement of the selector mechanism. Each one of the plurality of cavities fluidly couples at least two of the plurality of lines. The selector mechanism is movable between a cooling mode and a heating mode so that the cavities fluidly couple different ones of the plurality of lines in each of the cooling mode and the heating mode. The selector mechanism will maintain its position with respect to the plurality of lines when the source of motion is de-energized, regardless of a pressure differential between different ones of the plurality of lines.

### CROSS REFERENCE TO RELATED APPLICATIONS

The present application is related to, and claims the priority benefit of, U.S. Provisional Patent Application Ser. No. 61/887,269 filed Oct. 4, 2013, the contents of which are hereby incorporated in their entirety into the present disclosure.

### TECHNICAL FIELD OF THE DISCLOSED EMBODIMENTS

The presently disclosed embodiments generally relate to appliances for heating, ventilating and air conditioning (HVAC), and more particularly, to a device and method for reducing the power consumption of a reversing valve.

### BACKGROUND OF THE DISCLOSED EMBODIMENTS

In a residential heat pump the flow direction of the refrigerant is reversed when altering the mode of operation of the heat pump. In particular, during a cooling mode, the refrigerant flows from compressor discharge outlet to an outdoor coil, and from a vapor line to a compressor suction inlet. During a heating mode, the refrigerant flows from the compressor discharge outlet to the vapor line, and from the outdoor coil to the compressor suction inlet. The flow direction between the modes is generally controlled by a solenoid valve, which is called a “reversing valve.” Reversing valves that are currently used in residential heat pump systems utilize a solenoid that requires that the actuating motor stay energized. Accordingly, during operation, the valve consumes approximately 10 watts of power during the cooling cycle. Additionally, the current design of reversing valves requires a differential pressure of approximately 10 psi to 20 psi to properly engage.

### SUMMARY OF THE DISCLOSED EMBODIMENTS

In one aspect, a heat pump is provided including a plurality of lines having refrigerant flowing therethrough. A reversing valve is provided including a selector mechanism having a plurality of cavities formed therein and extending therethrough. In one embodiment, the selector mechanism is a plate or the like. A source of motion is coupled to the selector mechanism for movement of the selector mechanism. Each one of the plurality of cavities fluidly couples at least two of the plurality of lines. The selector mechanism is movable between a cooling mode and a heating mode so that the cavities fluidly couple different ones of the plurality of lines in each of the cooling mode and the heating mode. The selector mechanism will maintain its position with respect to the plurality of lines when the source of motion is de-energized, regardless of a pressure differential between different ones of the plurality of lines.

In another aspect, a reversing valve for a heat pump having a plurality of lines with refrigerant flowing therethrough is provided. The reversing valve includes a selector mechanism having a plurality of cavities formed therein and extending therethrough. A source of motion is coupled to the selector mechanism for movement of the selector mechanism. Each one of the plurality of cavities fluidly couples at least two of the plurality of lines. The selector mechanism is movable between a cooling mode and a heating mode so that the cavities fluidly couple different ones of the plurality of lines in each of the cooling mode and the heating mode. The selector mechanism will maintain its position with respect to the plurality of lines when the source of motion is de-energized, regardless of a pressure differential between different ones of the plurality of lines.

In another aspect, a method for changing the operation of a heat pump is provided. The heat pump includes a plurality of lines including a compressor discharge outlet, a compressor suction inlet, an outdoor coil, and a vapor line. The method includes rotating a selector mechanism having a plurality of cavities between a cooling mode and a heating mode with a source of motion. The selector mechanism is rotated so that one of the plurality of cavities fluidly couples the compressor discharge outlet to the vapor line and the other cavity fluidly couples the compressor suction inlet to the outdoor coil in the cooling mode. The selector mechanism is rotated so that one of the cavities fluidly couples the compressor discharge outlet to the outdoor coil and another cavity fluidly couples the compressor suction inlet to the vapor line in the heating mode. A position of the selector mechanism is maintained with respect to the plurality of lines when the source of motion is de-energized, regardless of a pressure differential between different ones of the plurality of lines.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a schematic diagram of a heat pump refrigerant system;

FIG. 2 is a schematic side view of a valve formed in accordance with an embodiment;

FIG. 3 is a schematic top view of a selector mechanism formed in accordance with an embodiment and in a cooling mode operation;

FIG. 4 is a schematic top view of the selector mechanism shown in FIG. 3 in a heating mode operation; and

FIG. 5 is a schematic top view of a ratchet system formed in accordance with an embodiment.

FIG. 6 is a schematic top view of a selector mechanism formed in a accordance with another embodiment.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

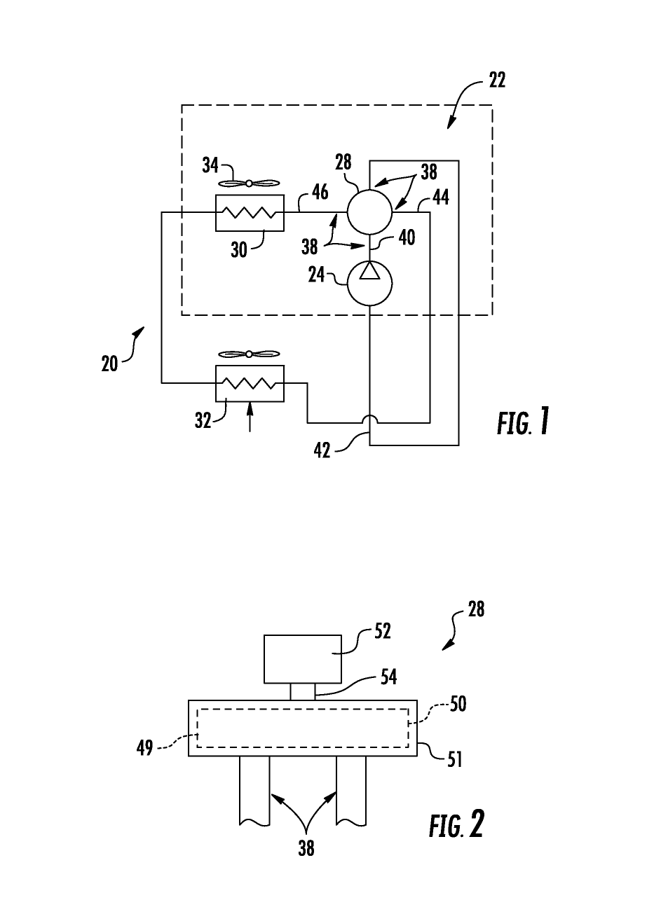

A HVAC system 20 is illustrated in FIG. 1 having a compressor 24. While only one compressor 24 is shown, additional compressors may also be incorporated in series. Also, a multi-stage compressor arrangement can be employed and equally benefit from the presently disclosed embodiments. In one embodiment, the refrigerant system 20 includes a heat pump 22 including the compressor 24 and an outdoor heat exchanger 30. A switch, such as four-way valve 28, alternatively routes refrigerant from the discharge outlet of the compressor 24 either to the outdoor heat exchanger 30, when the heat pump 22 is in a cooling mode, or to an indoor heat exchanger 32, when the heat pump 22 is in a heating mode.

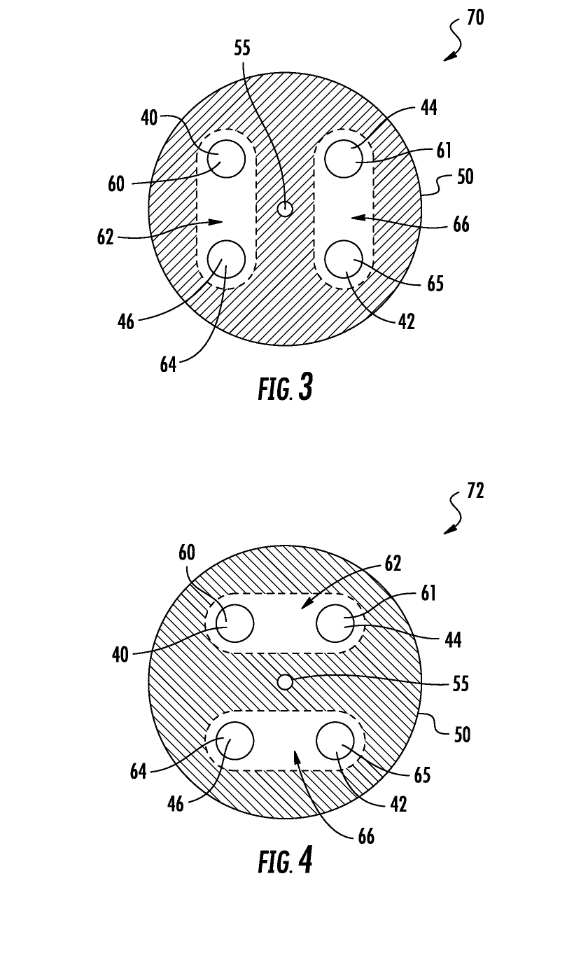

In one embodiment, the heat pump 22 includes a series of lines 38 that are coupled to the valve 28 for flow of refrigerant through the valve 28. The lines include a compressor discharge outlet 40, a compressor suction inlet 42, a vapor line 44, and an outdoor coil 46. FIG. 2 is a schematic side view of the valve 28 in an embodiment. In one embodiment, the valve 28 includes a selector mechanism 50 that is rotated between a cooling mode 70 (shown in FIG. 3) and heating mode 72 (shown in FIG. 4) by a motor 52. In one embodiment, the selector mechanism 50 is a plate or the like. The motor 52 is coupled to the selector mechanism 50 by a motor shaft 54 that extends through an aperture 55 (shown in FIGS. 3 and 4) in the selector mechanism 50. The aperture 55 is mechanically coupled to the motor shaft 54 so that the motor shaft 54 rotates the selector mechanism 50 when the motor 52 is energized.

As shown in FIGS. 3 and 4, the selector mechanism 50 is positioned within a housing 51 and rotates therein. The housing 51 includes a ports 60, 61, 64, and 65 fluidly coupled to the heat pump lines 38. In particular, port 60 is fluidly coupled to the compressor discharge outlet 40, port 61 is fluidly coupled to the vapor line 44, port 64 is fluidly coupled to the outdoor coil 46, and port 65 is fluidly coupled to the compressor suction inlet 42. The selector mechanism 50 has a thickness with two cavities 62 and 66 formed into the thickness. The ports 60, 61, 64, and 65 stay stationary while the cavities 62 and 66 rotate within the housing 51. When the selector mechanism 50 rotates to a new position, it allows refrigerant to flow from one connected port, through the cavity, and to the other connected port. For example, in the cooling mode configuration 70 shown in FIG. 3, the compressor discharge outlet 40 and the outdoor coil 46 are fluidly coupled through the first cavity 62; and the compressor suction inlet 42 and the vapor line 44 are fluidly coupled through the second cavity 66. In a heating mode configuration 72, shown in FIG. 4, the compressor discharge outlet 40 and the vapor line 44 are fluidly coupled through the first cavity 62; and the compressor suction inlet 42 and the outdoor coil 46 are fluidly coupled through the second cavity 66. The selector mechanism 50 is in sealing contact with the inside of the housing so that the refrigerant is maintained within the cavities 62 and 66.

The motor 52 rotates the selector mechanism 50 between the cooling mode configuration 70 and the heating mode configuration 72. In one embodiment, the selector mechanism 50 is rotated approximately 90 degrees between the cooling mode configuration 70 and the heating mode configuration 72. In an embodiment, the selector mechanism 50 rotates only clockwise. Accordingly, as the selector mechanism 50 rotates into the cooling mode configuration 70, either the first cavity 62 or the second cavity 66 may fluidly couple the compressor discharge outlet 40 and the outdoor coil 46; and the other of the first cavity 62 and the second cavity 66 fluidly couples the compressor suction inlet 42 and the vapor line 44. Likewise, in the heating mode configuration 72, either the first cavity 62 or the second cavity 66 may fluidly couple the compressor discharge outlet 40 and the vapor line 44, and the other of the first cavity 62 and the second cavity 66 fluidly couples the compressor suction inlet 42 and the outdoor coil 46.

In one embodiment, the motor 52 is a direct current motor that rotates the selector mechanism 50 when energized. Particularly, ratchets (not shown) are positioned in the housing 51 adjacent an outer periphery 49 (shown in FIG. 2) of the selector mechanism 50. The ratchets engage a feature (not shown) on the outer periphery 49 of the selector mechanism 50, so that interference between the feature and the ratchet surface prevents the selector mechanism 50 from rotating when the motor 52 is de-energized. When energized, the force created by the motor 52 is enough to overcome the resistance of the ratchet surface so that the selector mechanism 50 may be rotated. In another embodiment, the motor 52 is a stepper motor that rotates the selector mechanism 50 via the motor shaft 54 when the motor is energized. The stepper motor includes a plurality of meshed gears which operate to hold the selector mechanism 50 in position when the stepper motor is not energized. In one embodiment, the heat pump 22 includes a control panel (not shown) that activates the motor 52 when the motor 52 is required to rotate the selector mechanism 50 to switch the heat pump 50 from the cooling mode configuration 70 to the heating mode configuration 72 or vice versa.

The embodiments described herein only require a power draw when the motor 52 is activated to rotate the selector mechanism 50. Accordingly, a continuous power draw is not required. Additionally, the selector mechanism 50 is held in position either by the set of ratchets, when using a direct current motor, or the gears of the motor, when using a stepper motor. Accordingly, the embodiments described herein do not require a continuous pressure to maintain a position of the valve. By eliminating the need for continuous power draw and continuous pressure, the embodiments described herein provide an increased energy efficiency for the heat pump 22.

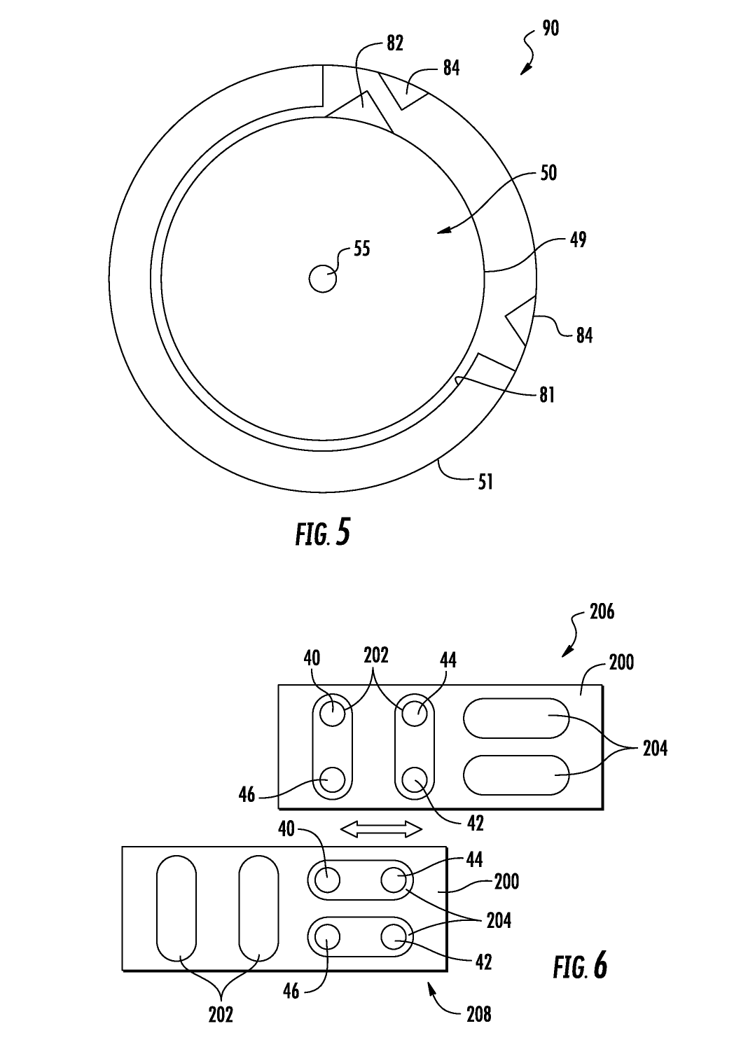

FIG. 5 is a schematic view of a ratchet system 90 that may be used with the valve 28 shown in FIGS. 2-4. The selector mechanism 50 is positioned within the housing 51 so that the outer periphery 49 of the selector mechanism 50 is positioned adjacent an inner surface 80 of the housing 51. A ratchet or bump 82 extends from the outer periphery 49 of the selector mechanism 50 toward the inner surface 80 of the housing 51, and ratchets or bumps 84 extends from the inner surface 80 of the housing 51 toward the outer periphery 49 of the selector mechanism 50. The selector mechanism 50 rotates with the rotation of the motor shaft 55. The ratchets 82 and 84 are sized to prohibit the selector mechanism 50 from rotation when the motor 52 is not energized. To rotate the selector mechanism 50 the motor 52 is energized and overcomes the barrier that the ratchets 82 and 84 impose. Additionally, in order to achieve rotation in both directions, a DC motor is connected to a control board (not shown) that includes a relay to reverse the voltage going to the motor leads. The motor 52 could be turned off once it reaches the full 90 degree rotation through several different means, for example a reed switch, a torque measurement (through amperage draw measurement), a contact switch, or the like.

FIG. 6 is a schematic view of another embodiment of a selector mechanism 200 that is moved by linear motion. The selector mechanism 200 includes a first pair of cavities 202 and a second pair of cavities 204. The first pair of cavities 202 extend a length that is perpendicular to the length of the second pair of cavities 204. In a cooling mode configuration 206, the compressor discharge outlet 40 and the outdoor coil 46 are fluidly coupled through one of the first pair of cavities 202; and the compressor suction inlet 42 and the vapor line 44 are fluidly coupled through a second of the first pair of cavities 202. In a heating mode configuration 208, the compressor discharge outlet 40 and the vapor line 44 are fluidly coupled through one of the second pair of cavities 204; and the compressor suction inlet 42 and the outdoor coil 46 are fluidly coupled through the other of the second pair of cavities 204. The selector mechanism 200 is moved linearly by a source of motion between the cooling mode configuration 206 and the heating mode configuration 208. The selector mechanism 200 maintains its position with respect to the plurality of lines when the source of motion is de-energized, regardless of a pressure differential between different ones of the plurality of lines.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A heat pump comprising:
a plurality of lines having refrigerant flowing therethrough; and
a reversing valve comprising a selector mechanism having a plurality of cavities formed therein and extending therethrough, wherein each one of the plurality of cavities fluidly couples at least two of the plurality of lines, wherein the selector mechanism is movable between a cooling mode and a heating mode so that the cavities fluidly couple different ones of the plurality of lines in each of the cooling mode and the heating mode.

2. The heat pump of claim 1, wherein respective ones of the plurality of lines are coupled to a compressor discharge outlet, a compressor suction inlet, an outdoor coil, and a vapor line, wherein, in the cooling mode, one of the plurality of cavities fluidly couples the compressor discharge outlet to the outdoor coil and another of the plurality of cavities fluidly couples the compressor suction inlet to the vapor line.

3. The heat pump of claim 2, wherein, in the heating mode, one of the plurality of cavities fluidly couples the compressor discharge outlet to the vapor line and another one of the plurality of cavities fluidly couples the compressor suction inlet to the outdoor coil.

4. The heat pump of claim 1 further comprising a motor to rotate the selector mechanism between the cooling mode and the heating mode.

5. The heat pump of claim 4, wherein a motor shaft couples the motor to the selector mechanism.

6. The heat pump of claim 5, wherein the motor is a direct current motor, the selector mechanism including a set of ratchets that retain a position of the selector mechanism when the direct current motor is not energized.

7. The heat pump of claim 5, wherein the motor is a stepper motor having gears that retain a position of the selector mechanism when the stepper motor is not energized.

8. The heat pump of claim 1, wherein the selector mechanism rotates approximately 90 degrees between the cooling mode and the heating mode.

9. A reversing valve for a heat pump having a plurality of lines with refrigerant flowing therethrough, the reversing valve comprising:
a selector mechanism having a plurality of cavities formed therein and extending therethrough;
a source of motion coupled to the selector mechanism for movement of the selector mechanism;
wherein each one of the plurality of cavities fluidly couples at least two of the plurality of lines;
wherein the selector mechanism is movable between a cooling mode and a heating mode so that the cavities fluidly couple different ones of the plurality of lines in each of the cooling mode and the heating mode; and
wherein the selector mechanism will maintain its position with respect to the plurality of lines when the source of motion is de-energized, regardless of a pressure differential between different ones of the plurality of lines.

10. The valve of claim 9, wherein respective ones of the plurality of lines are coupled to a compressor discharge outlet, a compressor suction inlet, an outdoor coil, and a vapor line, wherein, in the cooling mode, one of the plurality of cavities fluidly couples the compressor discharge outlet to the outdoor coil and another of the plurality of cavities fluidly couples the compressor suction inlet to the vapor line.

11. The valve of claim 10, wherein, in the heating mode, one of the plurality of cavities fluidly couples the compressor discharge outlet to the vapor line and another one of the plurality of cavities fluidly couples the compressor suction inlet to the outdoor coil.

12. The valve of claim 9, wherein the heat pump includes a direct current motor having a motor shaft, the selector mechanism further comprising a set of ratchets that retain a position of the selector mechanism when the direct current motor is not energized.

13. The valve of claim 9, wherein the heat pump includes a stepper motor having gears, a position of the selector mechanism retained by the stepper motor gears when the stepper motor is not energized.

14. The valve of claim 9, wherein the selector mechanism rotates approximately 90 degrees between the cooling mode and the heating mode.

15. A method for changing the operation of a heat pump, wherein the heat pump includes a plurality of lines including a compressor discharge outlet, a compressor suction inlet, an outdoor coil, and a vapor line, the method comprising:
rotating a selector mechanism having a plurality of cavities between a cooling mode and a heating mode with a source of motion;
rotating the selector mechanism so that one of the plurality of cavities fluidly couples the compressor discharge outlet to the vapor line and the other cavity fluidly couples the compressor suction inlet to the outdoor coil in the cooling mode;
rotating the selector mechanism so that one of the cavities fluidly couples the compressor discharge outlet to the outdoor coil and another cavity fluidly couples the compressor suction inlet to the vapor line in the heating mode; and
maintaining a position of the selector mechanism with respect to the plurality of lines when the source of motion is de-energized, regardless of a pressure differential between different ones of the plurality of lines.

16. The method of claim 15 further comprising rotating the selector mechanism between the cooling mode and the heating mode with a motor.

17. The method of claim 16 further comprising rotating the selector mechanism between the cooling mode and the heating mode with a motor shaft coupled between the motor and the selector mechanism.

18. The method of claim 17, wherein the selector mechanism includes a set of ratchets positioned along an interior surface thereof, the method further retaining a position of the selector mechanism with the set of ratchets when the direct current motor is not energized.

19. The method of claim 16 further comprising retaining a position of the selector mechanism with a plurality of motor gears when the motor is not energized.

20. The method of claim 15 further comprising rotating the selector mechanism approximately 90 degrees between the cooling mode and the heating mode.
